(19) United States
(12) Patent Application Publication
(10) Pub. No.: US 2018/0051983 A1
(43) Pub. Date: Feb. 22, 2018

(54) MEASUREMENT SYSTEM AND METHOD FOR CONFIGURING THE MEASUREMENT SYSTEM

(71) Applicant: CARL ZEISS INDUSTRIELLE MESSTECHNIK GMBH, OBERKOCHEN (DE)

(72) Inventors: Florian BAYER, OEHRINGEN (DE); Christian CONRAD, PFEDELBACH (DE); Heiko GOLLER, OBERSULM (DE); Ivan KAUSZ, OEHRINGEN (DE)

(21) Appl. No.: 15/678,538

(22) Filed: Aug. 16, 2017

(30) Foreign Application Priority Data
Aug. 17, 2016 (DE) 10 2016 115 252.8

(51) Int. Cl. G01B 11/25

(52) U.S. Cl. CPC G01B 11/2545; G01B 11/2513

(57) ABSTRACT

Measurement system for the three-dimensional optical measurement of a work-piece, comprising: (i) a camera for recording image data of the workpiece; (ii) a control unit which is configured to evaluate the image data recorded by the camera and deter-mine 3D data of the workpiece therefrom; and (iii) a projector for projecting a test pattern onto the workpiece. The control unit is configured to control the projector during a setup mode in such a way that the projector actively modifies, depending on a distance between the workpiece and the camera, the shape of the test pattern projected onto the workpiece in order, by way of the test pattern, to assist a user of the measurement system within the scope of positioning the camera relative to the workpiece.

### CROSS-REFERENCES TO RELATED APPLICATIONS

This application claims Convention priority to German patent application 10 2016 115 252.8, filed on Aug. 17, 2016. The entire content of this priority application is incorporated herein by reference.

### BACKGROUND OF THE INVENTION

The present disclosure relates to a measurement system for the three-dimensional optical measurement of a workpiece. The present disclosure further relates to a method for configuring the measurement system, which assists a user in positioning the measurement system in relation to a workpiece.

An exemplary measurement system of the type set forth above is known from DE 10 2011 008 655 A1.

Measurement systems of this type serve to check workpieces, for example as a part of quality assurance, or to determine the geometry of a workpiece completely as a part of what is known as “reverse engineering”. Moreover, diverse further application possibilities are conceivable, such as e.g. process-controlling applications, in which the measurement technique is applied directly for on-line monitoring and regulation of manufacturing and processing processes.

A common application example is that of checking vehicle body components in respect of possible manufacturing faults. To this end, the measurement system comprises an optical sensor which facilitates a contactless determination of the three-dimensional coordinates of the workpiece. The calculation of these 3D coordinates is normally based on an algorithmic evaluation of camera images which are supplied by at least one camera that is integrated into the sensor. In the vast majority of cases, this algorithmic evaluation is based on the principle of triangulation.

The components of the sensor that are required to apply the triangulation principle comprise a camera and, additionally, one or more further components which can be cameras or projectors and which are attached with an offset in relation to the first camera.

Independently of the employed image evaluation principle, a problem arising, as a matter of principle, in such measurement systems is that of “correctly” positioning the sensor or the camera relative to the workpiece to be measured. This is because the sensor or the camera must be positioned in such a way that the distance to the workpiece lies within the working volume defined by the sensor, within which the sensor supplies defined measurement results. In the ideal case, the sensor and the camera are positioned in such a way that the distance between the sensor and the measurement point on the surface of the workpiece is the same as the sensor-specific, nominal working distance and the measurement point lies directly in the focus of the camera. Even though a certain tolerance range exists in relation to the intended distance between the camera and the measurement point, this positioning of the measurement system relative to the workpiece, which is usually undertaken manually, is often a time-consuming and bothersome task for the user of the measurement system.

“Correctly” configuring or positioning the measurement system may be laborious for the user, particularly in scenarios in which the camera of the measurement system is guided by a robotic arm. In such scenarios, the robot and the workpiece to be measured are typically screened off in a so-called cell for safety reasons. However, the control unit, which controls the camera and evaluates the image data supplied by the camera, is typically installed outside of the cell. Although the user has access to the safety cell when configuring the measurement points on the workpiece, there is no desire to continuously return to the control unit of the measurement system outside of the cell in order to obtain feedback about the actual distance between the camera and the measurement point. Therefore, measurement points are often only taught approximately in practice. However, should it subsequently be determined that the deviation between the actual distance and the intended distance is too large, the measurement point must be taught again. This leads to great loss of time.

Therefore, there already are solutions in which the user is assisted during the configuration of the measurement system in such a way that there is signalling directly at the workpiece as to whether the distance between the camera and the workpiece lies within the defined working volume of the camera, within which the latter supplies defined measurement results. By way of example, measurement systems of the aforementioned type, in which two laser light sources each project a laser point onto the workpiece, are known. Here, the laser light sources are arranged in such a way that the two laser points are superimposed on a single point when the distance between the camera and the workpiece corresponds to the desired working distance. An example of a measurement system in which this solution is used is the product distributed by the applicant under the name of “COMET L3D”.

Instead of two laser points, e.g. a circle and a line are projected onto the workpiece in accordance with other solutions, with the projected line being centrally superimposed on the projected circle when the actual distance corresponds to the intended distance. However, this solution, too, is based on fixedly installed laser light sources. An example in which the last-mentioned solution is used is the product distributed by the applicant under the name of “T-SCAN”.

Even though the two aforementioned solutions have proven their worth in practice, they are disadvantageous in that further components in addition to the camera and the projector need to be housed in the measurement system, namely e.g. the laser light sources, for example in the case of measurement systems which operate with structured light projections. Due to tolerances during the production of the measurement system, the additional components, i.e., for example, the laser light sources, need to be calibrated for each measurement system to be built. Otherwise, possible inaccuracies have to be accepted, but this is not advisable in the vast majority of applications.

### SUMMARY OF THE INVENTION

It is thus an object to provide a measurement system for the three-dimensional optical measurement of a workpiece, which is improved to the extent that it simplifies the configuration of a measurement point, i.e. the “correct” positioning of the camera of the measurement system relative to the workpiece, for the user.

In accordance with an aspect of the present disclosure, a measurement system is presented which comprises: (i) a camera for recording image data of the workpiece; (ii) a control unit which is configured to determine 3D data of the workpiece based on the image data; and (iii) a projector for projecting a test pattern onto the workpiece. The control unit is configured to control the projector during a setup mode in such a way that the projector actively modifies, depending on a distance between the workpiece and the camera, the shape of the test pattern projected onto the workpiece in order to assist a user of the measurement system by means of the test pattern to position the camera relative to the workpiece.

In accordance with a further aspect of the present disclosure, a method for configuring the measurement system is proposed, said method comprising the steps of:
recording image data of the workpiece by means of a camera;
determining 3D data of the workpiece based on the image data;
projecting a test pattern onto the workpiece;
modifying a distance between the camera and the workpiece; and
modifying the shape of the test pattern projected onto the workpiece depending on the distance between the workpiece and the camera

The proposed solution allows the user to be provided with feedback in relation to whether the distance between the camera and the workpiece is too small, too large or at the defined working distance or in the tolerance region thereof, in real-time during the configuration of the measurement system. The feedback is brought about by projecting a so-called test pattern directly onto the workpiece itself. On the basis of the shape of the test pattern, which is actively modified by the evaluation and control unit depending on the distance between the camera and the workpiece, the user is therefore able to directly read from the workpiece whether the camera is, or is not, positioned at a “correct” distance from the workpiece.

The selection of the test pattern depends on the current distance between the camera and the workpiece and it is selected in such a way that it assists the user of the measurement system with the positioning of the measurement system, to be precise within the meaning of the user obtaining information as to whether the sensor is too far from, too close to or at the right distance from the workpiece.

The user running to and from, as occurs in the example set forth at the outset, in which the camera of the measurement system is arranged at a robotic arm and the control unit is arranged outside of the safety cell, within which the robot is situated, is no longer necessary when the measurement system according to this disclosure is used. The user can turn their attention to the workpiece or the test object at all times as feedback about the actual distance between the camera and the targeted measurement point on the workpiece is obtained directly by means of the test pattern on the workpiece or on the test object.

A further advantage of the herein presented solution is that the measurement system makes do without additional components since only the camera, the control unit and the projector are used as positioning aids; these are anyhow components of such a measurement system and, for example, are components that are anyhow required for evaluations on the basis of the structured light projection principle.

In the present case, the term “test pattern” should be interpreted broadly. This can be understood to mean any type of projected pattern. This may also include numbers or letters. In the present case, the addition of “test” is only used for distinguishing the term from another pattern, which is explained further below and which is referred to as measurement pattern.

The herein presented solution proposes actively modifying the shape of the test pattern depending on the distance between the camera and the workpiece. A change in size of a projected pattern which in any case occurs automatically within the scope of a change in distance is not considered to be an active shape modification within the present meaning. Preferably, the change in the shape of the test pattern contains a change in size, a change in the external form, a change in the projection frequency and/or a change in the colour of the test pattern.

In a refinement, the control unit is configured to determine the distance between the workpiece and the camera on the basis of the image data recorded by the camera. Hence, also the distance is determined by way of the camera and the control unit. Additional components, such as e.g. a separate distance sensor, are therefore not required.

Preferably, the camera is configured to record the test pattern projected by the projector onto the workpiece during the setup mode such that the image data recorded by the camera during the setup mode contain an image of the test pattern, wherein the control unit is configured to determine the distance between the workpiece and the camera based on the image of the test pattern algorithmically by means of triangulation.

Thus, in accordance with the last-mentioned configuration, the test pattern is not only used as a pure display for the user, which serves as a positioning aid for the measurement system. The test pattern simultaneously also serves for determining the distance between the camera and the workpiece. To this end, the projector projects the test pattern onto the workpiece, with the test pattern being captured by way of the camera at the same time and being evaluated in the control unit. On the basis of the evaluated test pattern, the actual distance of the camera from the target point (ideally the measurement point) on the workpiece can then be ascertained by way of known triangulation algorithms.

Therefore, in accordance with a further refinement, the test pattern preferably comprises at least one straight stripe, which can be used in the triangulation algorithm for determining the spatial coordinates of the workpiece or of the measurement point on the workpiece. It goes without saying that the camera can alternatively also be configured as a stereo camera. In this case, the projection of the test pattern only serves to provide the user with feedback about the actual distance, but it is not mandatory for determining the actual distance.

In accordance with a further refinement, the control unit is configured to control the projector during the setup mode in such a way that the projector projects a first test pattern onto the workpiece when the distance that is determined by the control unit lies within a predetermined tolerance range and that the projector projects a second test pattern onto the workpiece when the distance that is determined by the control unit lies outside of the predetermined tolerance range, with the first test pattern differing from the second test pattern in terms of its form.

By way of example, the two aforementioned test patterns could be two different pictograms: a first pictogram which indicates to the user that an actual distance between the camera and the workpiece is set “correctly”; and a second pictogram which indicates to the user that the actual distance between the camera and the workpiece is set “incorrectly” and must therefore be modified.

In accordance with a further refinement, the control unit is configured to control the projector during the setup mode in such a way that the projector projects a first test pattern onto the workpiece when the distance that is determined by the control unit lies within a predetermined tolerance range and that the projector projects a second test pattern onto the workpiece when the distance that is determined by the control unit is greater than an upper limit of the predetermined tolerance range and that the projector projects a third test pattern onto the workpiece when the distance that is determined by the control unit is less than a lower limit of the predetermined tolerance range.

Thus, it is immediately clear to the user from the shape of the test pattern whether the camera must be moved closer toward the workpiece, must be moved further away from the workpiece or is able to remain in its current actual position. To this end, use can be made of e.g. three different symbols or pictograms which, for example, may contain directional arrows.

In accordance with a further refinement, the control unit is configured to control the projector during the setup mode in such a way that the projector modifies the shape of the test pattern projected onto the workpiece dynamically and at least partly continuously depending on the distance that is determined by the control unit.

In the aforementioned example, which contains the use of three different test patterns, use can be made of e.g. pictograms with arrow symbols, the colour, position, alignment and/or size of which is modified continuously, to be precise once again depending on the distance between the camera and the workpiece. The control unit may thus be programmed for the following scenario: To the extent that the measured actual distance is greater than the upper limit of the predetermined tolerance range, the second test pattern is projected onto the workpiece. Changes in the actual distance within this region (above the upper limit) then lead to a modification of the colour, the size, the position and/or the alignment of the second test pattern. To the extent that, by contrast, the measured actual distance is smaller than the lower limit of the predetermined tolerance range, the third test pattern is projected onto the workpiece. Changes within this region (i.e. below the lower limit) correspondingly lead to a modification of the colour, size, position and/or alignment of the third test pattern. By contrast, changes in the actual distance within the tolerance range need not necessarily lead to a modification of the colour, size, position and/or alignment of the first test pattern. Thus, in this case, the first test pattern may be e.g. a static pattern which, unlike the second test pattern and third test pattern, is not modified continuously depending on the measured actual distance. However, it is understood that multifaceted further examples of this type, in particular in relation to the modification of the shape of the test pattern, are conceivable without departing from the scope of the present disclosure.

In accordance with a further refinement, information relating to the distance between the workpiece and camera that is determined by the control unit is contained in the projected test pattern. By way of example, the test pattern may contain numerical values and/or a projected scale.

In this way, the user can obtain exact feedback in respect of the actual distance in real time, for example by way of the specification in cm or mm.

In accordance with a further refinement, the control unit is configured to control the projector during a measurement mode in such a way that the projector projects a measurement pattern onto the workpiece, wherein the camera is configured to record the measurement pattern projected onto the workpiece by the projector during the measurement mode such that the image data recorded by the camera during the measurement mode contain an image of the measurement pattern, wherein the control unit is configured to determine the 3D data of the workpiece algorithmically by means of triangulation on the basis of the image of the measurement pattern.

This measurement pattern is preferably a static or dynamically modified pattern that comprises a plurality of straight stripes. Determining 3D data of a workpiece by way of such a structured light projection evaluation is already known from the prior art. However, it is advantageous in the present case that the same projector which is used to project the measurement pattern that is used during the measurement mode can also be used for the projection of the test pattern that is used during the setup mode. Thus, additional components are not required.

Preferably, the measurement system can be switched manually between setup mode and measurement mode. In this way, the user can initially configure the measurement system easily during the setup mode in order subsequently, after the configuration has been completed, to switch the measurement system into the measurement mode, in which the workpiece can be measured as specified above.

In accordance with a further refinement, the measurement system comprises a sensor unit which is arranged in a housing, wherein the camera and the projector are part of this sensor unit arranged in the housing.

Thus, the camera and the projector are preferably arranged in one and the same housing, which not only saves space but also eases the handling of the measurement system. In this case, the actual distance to be determined, discussed above, is the distance between the sensor unit and the workpiece in each case. This distance than preferably corresponds to the distance between the camera and the workpiece or the distance between the projector and the workpiece.

It is understood that the aforementioned features and those yet to be explained below may be used not only in the respectively specified combination but also in other combinations or on their own, without departing from the spirit and scope of the present disclosure.

### BRIEF DESCRIPTION OF THE DRAWINGS

Exemplary embodiments are shown in the drawings and are explained in greater detail in the following description. In the drawings:

FIG. 1 shows an illustration of an exemplary application of the herein presented measurement system;

FIG. 2 shows a schematic illustration of an exemplary embodiment of the measurement system;

FIG. 3 shows a schematic illustration of the exemplary embodiment shown in FIG. 2 during a setup mode;

FIG. 4 shows an example of a test pattern in a view as may be visible on the workpiece to a user in reality (see part A) and the 2-D view thereof on a graphical user interface (see part B);

FIG. 5 shows a further example of a test pattern in a view as may be visible on the workpiece to a user in reality (see part A) and the 2-D view thereof on a graphical user interface (see part B);

FIG. 6 shows a further example of a test pattern in a view as may be visible on the workpiece to a user in reality (see part A) and the 2-D view thereof on a graphical user interface (see part B).

### BRIEF DESCRIPTION OF THE DRAWINGS

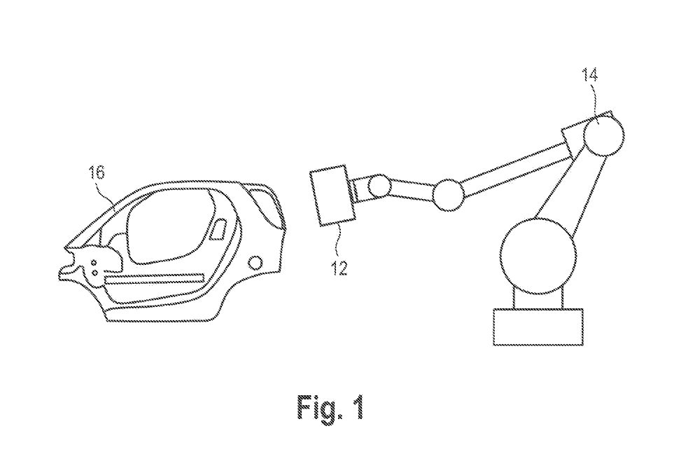

FIG. 1 shows an exemplary application, in which the measurement system according to this disclosure can be used in practice.

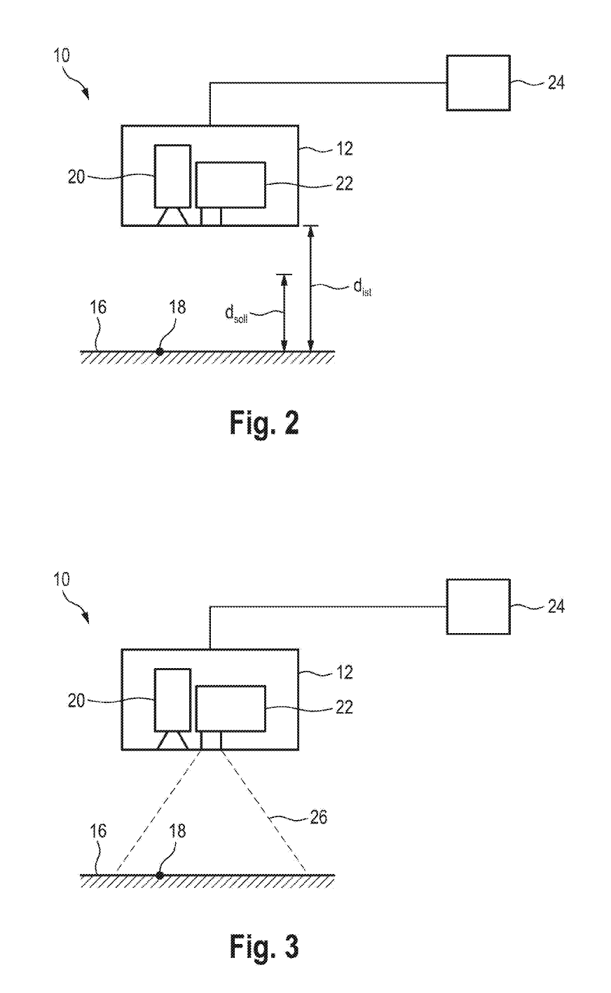

FIGS. 2 and 3 shows schematic detailed illustrations of an exemplary embodiment of the measurement system, for the purposes of explaining the components of the measurement system and for the purposes of explaining the function thereof.

The measurement system is denoted in the figures as a whole by reference numeral 10. A part of the measurement system 10, which is referred to as a sensor unit 12 in the present case, is arranged on an arm of a robot 14 in the exemplary case illustrated in FIG. 1. Here, the sensor unit 12 is aligned on a workpiece 16 or on a part of a workpiece 16 which is intended to be measured with the aid of the measurement system 10. In the application illustrated in an exemplary manner in FIG. 1, the workpiece 16 is a body component of a vehicle.

The three-dimensional measurement of the workpiece 16 undertaken with the aid of the measurement system 10 serves to determine 3D data of the workpiece, on the basis of which it is possible, for example, also to determine the surface character thereof in detail, in addition to the surface geometry of the workpiece 16. The 3D data are usually determined as a 3D point cloud which originates from a multiplicity of different measurement points on the surface of the workpiece 16. An exemplary measurement point is denoted by reference numeral 18 in FIGS. 2 and 3.

The workpiece 16 is measured by the measurement system 10 in an optical manner. To this end, the measurement system 10 comprises a camera 20 (see FIGS. 2 and 3). Further, the measurement system 10 also contains a projector 22 and a control unit 24.

The camera 20 and the projector 22 are preferably, but not necessarily, arranged in one and the same housing. They belong to the sensor unit 12. By contrast, the control unit 24 is preferably arranged outside of the control unit 12. The components of the control unit 12 are connected to the control unit 24 either by means of one or more cables or by means of a wireless connection.

The control unit 24 is preferably a computing unit, i.e., for example, a computer or part of a computer. The control unit 24 contains hardware which has software installed thereon, said software serving both to evaluate the image data supplied by the camera 20 and to control the function of the camera 20 and of the projector 22.

Even though the camera 20 for measuring the workpiece 16 may, as a matter of principle, also be replaced by a plurality of cameras (e.g. a stereo camera), said camera is preferably configured as an individual camera in the present case. Thus, the workpiece 16 is preferably measured on the basis of the structured light projection principle, which is also referred to as structured light topometry.

The camera 20 can be configured as a digital or analogue video camera. In principle, use can also be made of two or more cameras 20.

The projector 22 is a projector which, in terms of the principle thereof, is similar to a slide projector.

During a measurement, the projector 22 illuminates, with a static pattern or a pattern that is modifiable in sequence over time, the part of the workpiece 16 to be measured, said pattern being referred to as measurement pattern in the present case. This measurement pattern preferably comprises a plurality of bright and dark stripes of different width that lie parallel to one another. The measurement pattern is recorded by the camera 20 at a known viewing angle in relation to the projector. Then, the image data recorded by the camera 20 are evaluated in the control unit 24. Ultimately, it is possible to determine the topography of the workpiece 16 on the basis of the deformations or distortions of the measurement pattern occurring in the image data. As a result, a multiplicity of measurement points on the workpiece 16 are evaluated in succession in this manner such that surface coordinates of the workpiece 16 are ultimately present as a 3D point cloud.

In order to correctly configure the measurement system 10, configuring the sensor unit 12 at a “correct” distance from the workpiece 16 is also, in addition to the mandatory calibration, of immense importance. The sensor unit 12 must be positioned in such a way that the distance between the sensor unit 12 and the measurement point 18 lies within a defined working volume, within which the sensor unit 12 supplies defined measurement results. In particular, the distance between the camera 20 and the measurement point 18 is of immense importance since it is not possible to accurately capture the measurement point 18 if the latter lies outside of the focus of the camera 20.

In FIG. 2, the actual distance between the sensor unit 12, or the camera 20, and the measurement point 18 is denoted by dᵢₛₜ and the intended distance between the sensor unit 12, or the camera 20, and the measurement point 18 is denoted by dₛₒₗₗ. The intended distance dₛₒₗₗ is often also referred to as nominal working distance. The latter is sensor specific. However, it is understood that there is a certain tolerance range in respect of the intended distance dₛₒₗₗ, within which the sensor unit 12 supplies reliable measurement results. By way of example, such a tolerance range may be the range of ±10% of the nominal working distance dₛₒₗₗ.

The measurement system 10 assists the user to bring the actual distance dᵢₛₜ as easily as possible to the nominal working distance dₛₒₗₗ by virtue of information about the actual distance dᵢₛₜ and the intended distance dₛₒₗₗ being presented on the workpiece 16 in real time. As a result of this, the user obtains the necessary information precisely where they usually look during the configuration of the measurement system 10, namely directly on the test object or workpiece 16.

To this end, the projector 22 projects a pattern onto the workpiece 16, which is captured at the same time by way of the camera 20. This is indicated in a simplified manner in FIG. 3 by way of a dashed line 26. The pattern which is projected onto the workpiece 16 for the purposes of configuring the measurement system 10 preferably differs from the measurement pattern which is used for the subsequent measurement according to the principle explained above. Therefore, in order to distinguish between these terms, the terms test pattern and measurement pattern are used in the present case. The test pattern is used during the so-called setup mode, during which the measurement system 10 is configured or the distance between the sensor unit 12 and the workpiece 16 is set. The measurement pattern is used during the so-called measurement mode, during which the workpiece 16 is subsequently measured with the aid of the measurement system 10.

By way of example, the setup mode proceeds as follows: In the first step, the projector 22, as already mentioned, projects a test pattern onto the surface of the workpiece 16. It is recorded by the camera 20. Then, the actual distance dᵢₛₜ between the sensor unit 12 and the workpiece 16 can be ascertained algorithmically on the basis of the image data recorded by the camera, in a manner similar to the measurement principle of the structured projection described above. The employed test pattern therefore likewise preferably comprises at least one straight stripe, on the basis of which the actual distance dᵢₛₜ can be calculated by way of the aforementioned evaluation method. Depending on the calculated actual distance dᵢₛₜ, the test pattern projected onto the workpiece 16 by the projector 22 then is modified in terms of its shape in order to provide the user with feedback about the actual distance dᵢₛₜ on the basis of the modified shape of the test pattern. Thus, to this end, the test pattern is actively modified by the control unit 24. This dynamic change in shape of the test pattern mainly serves to provide feedback to the user in order to assist during the positioning of the sensor unit 12. By contrast, the change in shape of the pattern would not be mandatory for measuring the actual distance dᵢₛₜ.

Therefore, at least the two following requirements should be met by the test pattern: Firstly, it should be evaluable by an algorithm in order to be able to determine the actual distance dᵢₛₜ in a suitable manner on the basis thereof. Secondly, it should uniquely encode or comprehensively display for the user how the actual distance dᵢₛₜ of the sensor unit 12 from the workpiece 16 should be modified in order to obtain the desired intended distance dₛₒₗₗ.

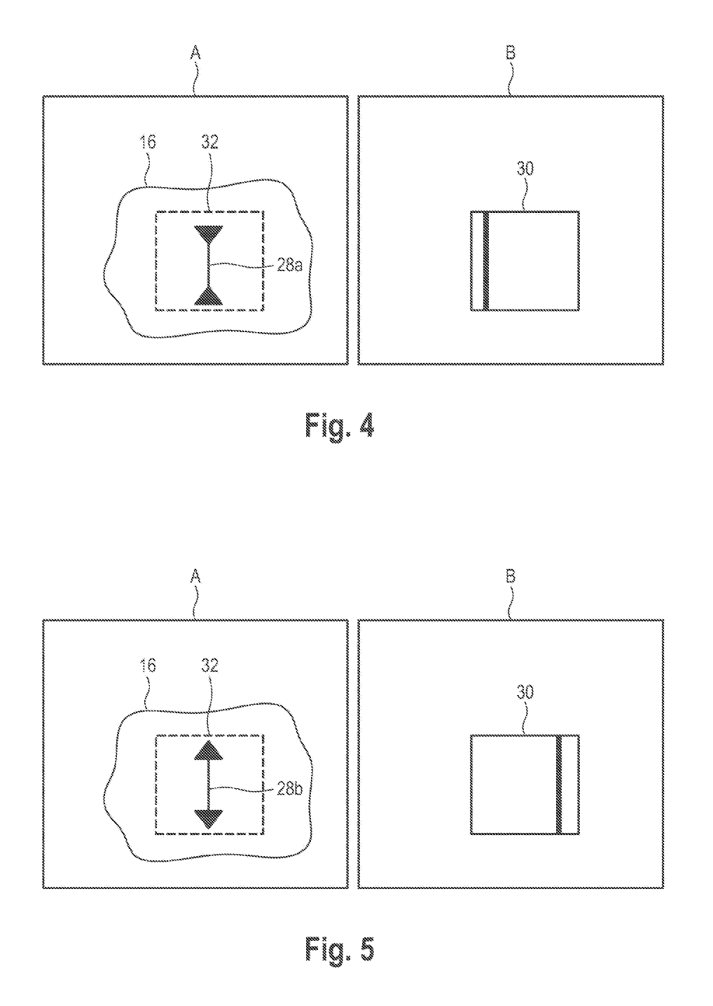

FIGS. 4-6 show three exemplary test patterns 28. The respective part A in FIGS. 4-6 schematically shows a section of the workpiece 16, onto which the respective test pattern has been projected. The respective part B in FIGS. 4-6 schematically shows a representation 30 of the projected pattern in the 2-D image recorded by the camera 20. The dashed line 32 in parts A of FIGS. 4-6, which surrounds the test patterns 28, is merely plotted for visual perception purposes in order to schematically elucidate the section of the projection cone or visual cone of the sensor unit 12.

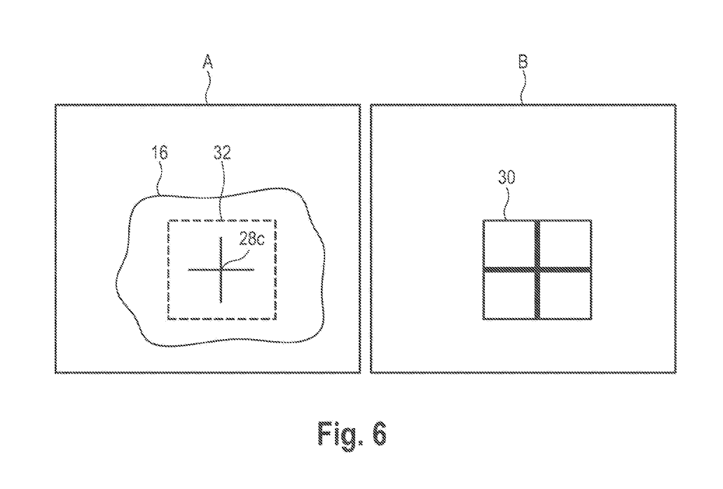

The first test pattern 28a, which is shown in FIG. 4, is e.g. projected onto the workpiece 16 if the actual distance dᵢₛₜ is too large (dᵢₛₜ>dₛₒₗₗ). With the aid of the arrows of the first test pattern 28a pointing toward one another, the user is provided with an indication that the actual distance dᵢₛₜ should be reduced. By contrast, the second test pattern 28b, which is shown in FIG. 5, is e.g. projected onto the workpiece 16 if the actual distance dᵢₛₜ is too small (dᵢₛₜ<dₛₒₗₗ). The arrows of the second test pattern 28b pointing away from one another should indicate to the user that the actual distance dᵢₛₜ should be increased. By contrast, the third test pattern 28c, which is illustrated in FIG. 6, can be projected onto the workpiece 16 if the actual distance has been set “correctly” (dᵢₛₜ=dₛₒₗₗ). The schematically presented crosshairs then signal to the user that the measurement unit 12 is positioned correctly relative to the measurement point 18 at the workpiece 16.

Reference is made to the fact that the test patterns 28a-28c shown in FIGS. 4-6 are merely one of many possible examples. In principle, use can be made of only two different test patterns 28, namely one to indicate that the actual distance dᵢₛₜ corresponds to the intended distance dₛₒₗₗ and a further one indicating that the actual distance dᵢₛₜ does not correspond to the intended distance dₛₒₗₗ.

Likewise, use can be made of only a single test pattern 28, the external shape of which is modified depending on the actual distance dᵢₛₜ. By way of example, the test pattern can be modified dynamically and continuously depending on the actual distance dᵢₛₜ.

In principle, the test pattern can be as desired. It may also be complemented as desired by further information, although this ideally does not impair the algorithmic evaluation for determining the actual distance dᵢₛₜ.

In principle, numbers, i.e., for example, the exact distance value dᵢₛₜ, may also be contained in the test pattern and projected onto the workpiece 16.

The algorithmic evaluability of the test pattern is not mandatory. In principle, the actual distance dᵢₛₜ may also be determined by way of a different distance sensor which does not operate by means of structured light projection. However, the advantage of determining the actual distance with the aid of the camera 20, the projector 22 and the control unit 24 is that, in this case, the already conventional components of the measurement system 10 are used for the distance measurement, and so no additional sensor is necessary.

What is claimed is:

1. Measurement system for a three-dimensional optical measurement of a workpiece, comprising:
a camera for recording image data of the workpiece;
a control unit which is configured to determine 3D data of the workpiece based on the image data; and
a projector for projecting a test pattern onto the workpiece;
wherein the control unit is configured to control the projector during a setup mode to actively modify the shape of the test pattern projected onto the workpiece depending on a distance between the workpiece and the camera.

2. Measurement system according to claim 1, wherein the control unit is configured to determine the distance between the workpiece and the camera based on the image data recorded by the camera.

3. Measurement system according to claim 2, wherein the image data recorded by the camera during the setup mode contain an image of the test pattern, and wherein the control unit is configured to determine the distance between the workpiece and the camera based on the image of the test pattern by means of triangulation.

4. Measurement system according to claim 1, wherein the test pattern comprises at least one straight stripe.

5. Measurement system according to claim 2, wherein the camera is a system comprising a plurality of cameras.

6. Measurement system according to claim 1, wherein the control unit is configured to control the projector during the setup mode to project a first test pattern onto the workpiece when the distance between the workpiece and the camera lies within a predetermined tolerance range and to project a second test pattern onto the workpiece when the distance between the workpiece and the camera lies outside of the predetermined tolerance range.

7. Measurement system according to claim 1, wherein the control unit is configured to control the projector during the setup mode to project a first test pattern onto the workpiece when the distance between the workpiece and the camera lies within a predetermined tolerance range and to project a second test pattern onto the workpiece when the distance between the workpiece and the camera is greater than an upper limit of the predetermined tolerance range and to project a third test pattern onto the workpiece when the distance between the workpiece and the camera is less than a lower limit of the predetermined tolerance range.

8. Measurement system according to claim 1, wherein the control unit is configured to control the projector during the setup to modify the shape of the test pattern projected onto the workpiece dynamically and at least partly continuously depending on the distance between the workpiece and the camera.

9. Measurement system according to claim 8, wherein information relating to the distance between the workpiece and camera is contained in the projected test pattern.

10. Measurement system according to claim 1, wherein the control unit is configured to control the projector during a measurement mode to project a measurement pattern onto the workpiece, wherein the camera is configured to record the measurement pattern during the measurement mode such that the image data recorded by the camera during the measurement mode contain an image of the measurement pattern, wherein the control unit is configured to determine the 3D data of the workpiece based on the image of the measurement pattern by means of triangulation.

11. Measurement system according to claim 10, wherein the measurement pattern is a static pattern.

12. Measurement system according to claim 10, wherein the measurement system is manually switchable between the setup mode and the measurement mode.

13. Measurement system according to claim 1, wherein the measurement system comprises a sensor unit which is arranged in a housing, wherein the camera and the projector are part of said sensor unit.

14. Method for configuring a measurement system for optical measurement of a workpiece, said method comprising the steps of:
recording image data of the workpiece by means of a camera;
determining 3D data of the workpiece based on the image data;
projecting a test pattern onto the workpiece;
modifying a distance between the camera and the workpiece; and
modifying the shape of the test pattern projected onto the workpiece depending on the distance between the workpiece and the camera.
